(19) United States
(12) Patent Application Publication
(10) Pub. No.: US 2007/0023347 A1
(43) Pub. Date: Feb. 1, 2007

(54) Liquid separation apparatus

(76) Inventor: Jean-Marie Chabot, St-Damien (CA)

Correspondence Address: NIXON & VANDERHYE, PC, 901 NORTH GLEBE ROAD, 11TH FLOOR, ARLINGTON, VA, 22203, US

(21) Appl. No.: 11/190,820

(22) Filed: Jul. 28, 2005

(51) Int. Cl. B01D 63/00

(52) U.S. Cl. 210/321.6; 210/321.83; 210/321.85; 417/321; 210/416.1

(57) ABSTRACT

A two-vessel liquid separation apparatus includes a pump and its motor submersed in a one vessel and a reverse osmosis membrane in the other vessel. The vessels are separated by a contiguous dividing wall. The membrane and the pump are in fluid communication with one another through the dividing wall so as to allow liquid to pass from one vessel to the other in accordance with a given geometry. The pump receives liquid from the membrane containing vessel through holes in the dividing wall, the pump creating a highly turbulent flow caused by a cyclonic and co-axial effect, directly at the lower end of the membrane; the connexion of the pump outlet at the dividing wall is very close to the membrane thus providing an optimal efficiency of turbulence and flow at critical locations of bacteria collection. The injection of new liquid to be concentrated at the inlet of the pump causes an immediate mixture of liquid to be concentrated with concentrated liquid, which mixture circulates rapidly in a close circuit between the first and second vessels.

### FIELD OF THE INVENTION

The invention relates to an apparatus for concentrating a liquid having materials in suspension (such as maple sap) by removing part of the water molecules therein in order to provide a concentrate ready for a subsequent operation, such as the evaporation of maple sap to obtain maple syrup as a finished product.

### BACKGROUND OF THE INVENTION

In the field of maple sap evaporation, for example, the average sugar rate prior to concentration may vary between 1% and 6% depending on the type of maple tree or the region where this type of tree grows. The percentage of concentrate after concentration may vary up to 2 to 8 times the percentage of sugar in the original sap.

Current maple sap concentration is between 8% and 10% prior to evaporation. The percentage of maple syrup sugar is 66% after evaporation. The usual energy required for this operation is derived from wood fire, oil heating or steam in a heat exchanger. Since it is required to reduce from 20 to 40 times the volume of sap in order to obtain an acceptable maple syrup of 66° Bricks, the practice of sap concentration by reverse osmosis has greatly reduced the costs of obtaining maple syrup from maple sap.

Many apparatuses to concentrate water liquids, such as salt water, polluted water, sugar water are presently commercialized; however, they all have different characteristics one from the other. These apparatuses are equipped with vessels enclosing a membrane which capable of molecular filtration which separate short molecules from long molecules of liquid when the latter is forced through a membrane at pressures which do not exceed 500 psi. The membrane is a synthetic micro tissue which is a coiled on a wire mesh support to form layers between which the liquid circulates by contacting the entire surface of the coiled membrane. Hence, the membrane must have a very large surface entirely exposed to liquid in order to optimize the concentration of the liquid flowing under pressure therethrough.

One major problem in concentrating maple sap or sweet liquids is the accumulation of bacteria in locations on the wire mesh support which are difficult to reach. This problem was not recognized in apparatuses which were used to soften water by reverse osmosis, except for those used for the concentration of sugar water. Such apparatus may be found described in U.S. Pat. No. 4,702,842 issued Oct. 27, 1987 to Lapierre or in applicant's Canadian application No. 2,347,485 published Nov. 15, 2001.

In order to minimize an accelerated formation of bacteria in those locations which are difficult to reach, the flow of sap inside the membrane-containing vessel must be maintained in an accelerated motion in order to perform self-cleaning in these locations. Sap deteriorates rapidly (such as milk which deteriorates when temperature is above 45° F.). Sap is collected from maple trees by means of a system of tubes operating under vacuum conditions at temperatures as high as 70° F. Sap must therefore be transformed rapidly in order to obtain syrup of acceptable quality.

Sap which lies in those areas of the membrane which are difficult of access at this temperature is transformed into a white creamy substance which quickly blocks the pores of the membrane thereby considerably reducing the reverse osmosis operation, thus resulting in frequent cleaning in order to maintain adequate circulation through the membrane.

### OBJECTS AND STATEMENT OF THE INVENTION

An object of the present invention is to optimize, in a liquid separation apparatus, the flow of liquid to be concentrated between the layers of the membrane (up to the maximum limit suggested by the membrane manufacturer) so as to favor maximum turbulence between the layers of the membrane.

The present invention therefore relates to a liquid separation apparatus which comprises:
a) a first vessel having a closed end;
b) a second vessel connected to the first vessel and having a closed end;
c) a dividing wall between the first vessel and the second vessel defining ends in the vessels opposite the closed ends of the vessels; the wall having liquid passages therethrough;
d) a plate mounted on the dividing wall in the first vessel;
e) a membrane of reverse osmosis consisting of coiled layers of liquid separation material confined in the first vessel and supported on the plate; the membrane being so distanced from the inner wall of the first vessel as to define an annular peripheral channel therebetween; the membrane having an axial passageway receiving permeate obtained as a result of concentration through the membrane; the axial passageway being blocked at the plate;
f) a submersed motor inside the second vessel;
g) a submersed pump inside the second vessel having one end connected to the motor for operation and an opposite end extending through the dividing wall and being in fluid connection with the membrane;
h) a pair of annular chambers in the second vessel; a first of the annular chambers being located adjacent the motor and being in fluid communication with the pump; a second of the annular chambers being located between the first chamber and an inner wall of the second vessel and being in fluid communication with the first annular chamber and with the annular channel of the first vessel through the passages of the dividing wall;
i) an inlet port to receive liquid to be separated; the inlet port being connected to the second annular chamber for mixture with concentrate received from the channel of the first vessel;
j) a first outlet port allowing concentrate to be collected outside the apparatus; and
k) a second outlet port in fluid communication with the axial passageway of the membrane allowing permeate to be collected outside the apparatus.

The injection of liquid to be concentrated in the vessel containing the pump is done directly at the inlet port of the pump where it is mixed with the concentrate, the mixture thus circulating in the vessels in a closed circuit. The new liquid which enters the second vessel is thus mixed immediately and instantaneously, prior to entering the pump, with the concentrate. The uniformity of the mixture is identical throughout the first vessel containing the membrane thereby minimizing the formation of bacteria and their growth during the entire operation.

The present apparatus therefore consists in submersing a pump and its motor in one of the cylindrical vessels. The pump forces the mixture of concentrate and new liquid to be concentrated axially and with a cyclonic effect directly at one end of the membrane which is very close to the membrane. This provides an optimal efficiency of flow turbulence at those critical locations of bacteria formation and plugging during the concentration process.

This method of injecting a new mixture of liquid and concentrate in the membrane allows to maintain a positive pressure between the layers of the membrane which tend to open in order to remove the bacteria deposits or particles which slow down the reverse osmosis effect. Maximum flow created by the circulation pump thereby remains quasi constant at all times thus maintaining a self-cleaning effect during operation. Plugging is thereby reduced at its minimum.

The flow configuration of the present apparatus ensures at all times a maximum flow of the circulating pump independently of concentrations in the liquid to be concentrated in the membrane. A circulation in an opposite direction would affect the flow of the pump; indeed, a membrane which is plugged may be compared to a valve which gradually closes on the feeding side of the circulating pump. Therefore, a membrane completely plugged provides no circulation, cavities and heating of the pump impeller while accelerating the degradation of the concentrate.

### BRIEF DESCRIPTION OF THE DRAWINGS

FIG. 1 is a longitudinal section of the apparatus;

FIG. 2 is a sectional view of the first vessel along line 2-2 of FIG. 1;

FIG. 3 is an enlarged view a part of the apparatus illustrating the circulation between the two vessels; and

FIG. 4 is a view similar to FIG. 3 showing the inlet and outlet of the vessels.

### DESCRIPTION OF PREFERRED EMBODIMENTS

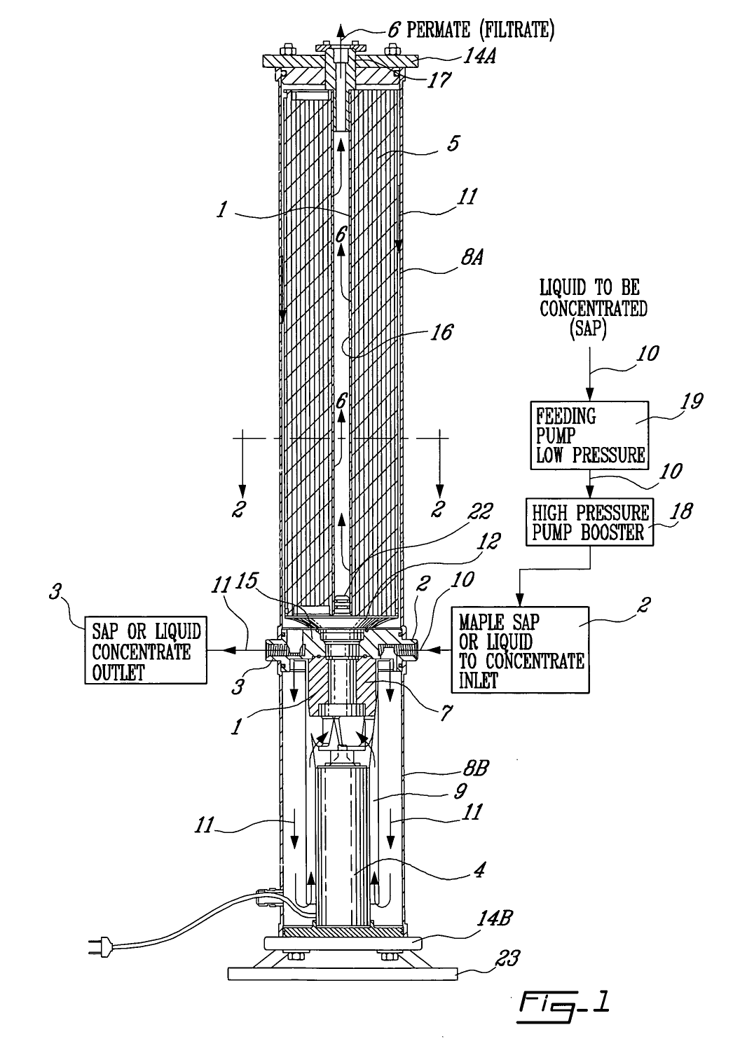

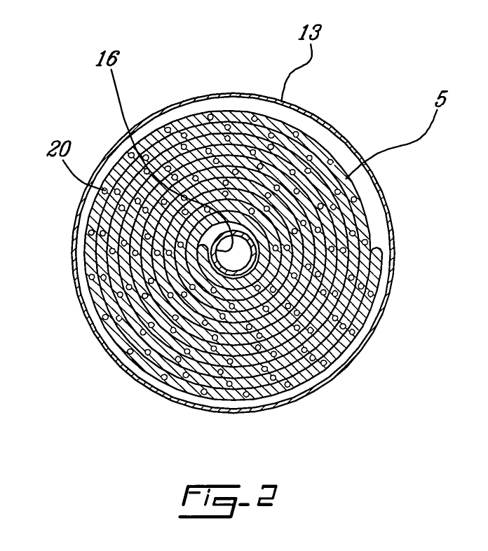

Referring to FIGS. 1 and 2, the liquid separation apparatus comprises a pair of watertight cylindrical vessels 8a and 8b which are closed at their opposite remote ends by caps 14a and 14b and at their common end by a dividing wall 15. A membrane 21 of synthetic fiber tissue is coiled onto a wire mesh grid 20 in vessel 8a. A pump 1 and its electric motor 4 are enclosed in vessel 8b. The motor 4 rotates the rotor 7 of the circulating pump 1. A feeding pump 19 of low pressure serves to inject liquid to be concentrated at the input of a high pressure booster pump 18 which, in turn, serves to maintain the pressure at an adequate value in vessels 8a and 8b in order to accelerate the reverse osmosis effect through the layers 5 of the membrane 21. A saucer plate 12 having an inverted cone shape and resting in liquid tight arrangement on the dividing wall 15 supports the membrane. The plate 12 has a central opening (not shown) in fluid communication with the upper end of the pump, thus ensuring the transfer of the liquid from the rotor 7 of the pump 1 towards the base of the layers 5 of the membrane 21.

The permeate outlet port 17 traverses the cap 14a at the upper end of the vessel 8a to evacuate purified water 6 (permeate) extracted from the concentrate from the central passageway 16 of the membrane. This outlet port 17 ensures a transfer of the purified water 6 outside of the apparatus. The outlet port 3 allows part of the concentrate 11 to be collected; in the case of maple concentrate, it is collected to thereafter be boiled for evaporation in order to obtain maple syrup.

Both vessels are secured to the dividing wall in maximum watertight connection in order to ensure a maximum flow of the mixture between the pump 1 and the membrane 21.

Operation of the System

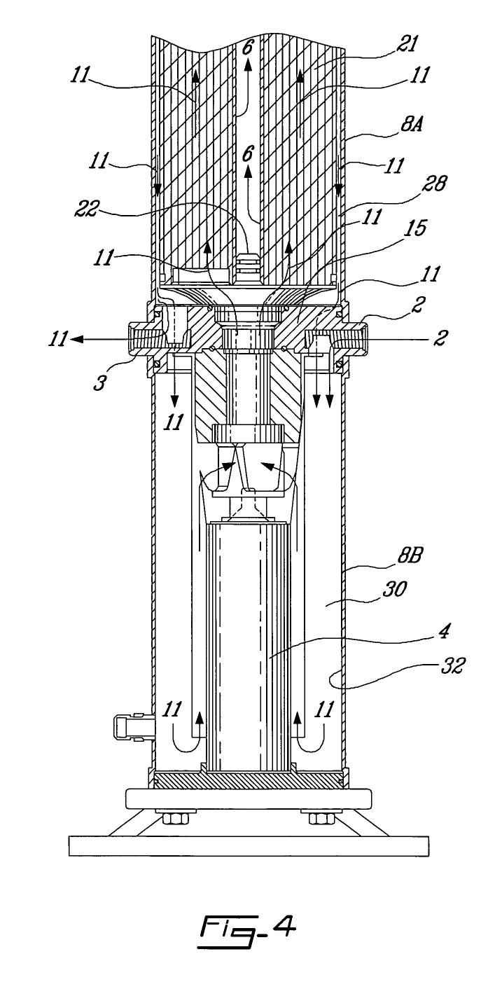

The liquid to be concentrated 10 comes from a reservoir (not shown) and passes through the feeding pump 19 which forces the liquid 10 at the input of the high pressure pump 18. Liquid 10 is then forced in the liquid separation apparatus by entering in the dividing wall 15 (such as shown in FIG. 4) by passing through inlet port 2 and is mixed to the concentrate 11 received from channel 28 of the vessel 8A the mixture entering the annular chamber 30 formed between the inner wall 32 of the vessel 8B and the tubular member 34; it then passes through the opened bottom of the tubular member 34 and up the annular chamber 9 to reach the pump 1. Liquid in chamber 9 also serves to cool the motor 4 since the tubular member 34 contacts the outer wall of the pump 1.

The circulating pump 1 forces a high flow (about seven times the volume of the pump 19) of the liquid 10 towards the inner layers 5 of the membrane 21. At a so short a distance from the membrane, a maximum turbulence is obtained thereby preventing dead points in the mesh grid 20 between the layers 5 of the membrane 21. The effect of turbulence is increased by the axial discharge of the re-circulating pump 1 which has a cyclonic effect.

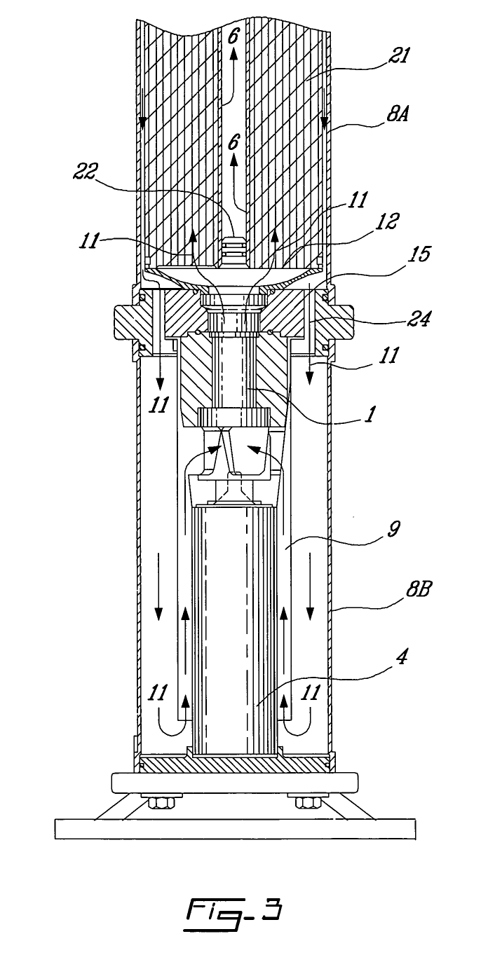

A closed circuit is created. Indeed, as described above, new liquid to be concentrated which enters vessel 8b immediately contacts the concentrate which flows from the channel 28 between the inside wall of vessel 8a and the membrane; hence, a perfect mixture is immediately obtained from the new liquid entering vessel 8b and the concentrate received from vessel 8a. The pump immediately forces the mixture between the layers 5 of the membrane 21 at high speed; this mixture will return to circulate between the outside wall of the membrane and the inside wall of vessel 8a in order to again traverse wall 15 by a series of holes 24 (see FIG. 3) and recirculate again between the inside wall of the vessel 8b and the outside wall of the tubular member 34 to finally arrive at the inlet of the pump 1 in order to terminate this closed circuit and to begin a new closed circuit, and so on during the entire process of concentration.

When the mixture 11 circulates from bottom to top and then from top to bottom, a portion of the mixture 11 is evacuated at outlet 3 on one side of the intermediate wall 15. The outflow at this outlet is adjusted by a valve (not shown) which is more or less open to control the percentage of material to concentrate (sugar in the case of sap) which one wishes to obtain.

The permeate 6 (water which is practically pure) which traverses the membrane is evacuated at the outlet port 17 towards a stock recipient or drain.

The capacity of the apparatus is a combination of the size of the pump, the size of the membrane and the number of vessels which can be interconnected in series or in parallel between one another. The total capacity of an apparatus is proportional to the number of vessels 8a and 8b in operation at all times. A watertight plug 22 must block all circulation of the mixture 11 in the central passageway of the membrane 21 which serves to evacuate the filtrate 6 from the vessel, to thereby ensure a separation approaching 100% between the water molecules and the material in suspension.

The vessels can operate in any position; if one wishes a vertical position, a base 23 is mounted to the cap 14b in order to maintain it in a vertical equilibrium.

Although the invention has been described above in relation to one specific form of the invention, it will be evident to a person skilled in the art that it can be refined and modified in various ways. Also, the present invention although described above in relation to the filed of the maple sap industry is also applicable, for example, to liquid manure, sugar juice or other liquids which require a separation of material in suspension therein. It is therefore wished that the present invention not be limited in scope except by the terms of the following claims.

1. A liquid separation apparatus, comprising:
a) a first vessel having a closed end;
b) a second vessel connected to said first vessel and having a closed end;
c) a dividing wall between said first vessel and said second vessel defining ends in said vessels opposite said closed ends of said vessels; said wall having liquid passages therethrough;
d) a plate mounted on said dividing wall in said first vessel;
e) a membrane of reverse osmosis consisting of coiled layers of liquid separation material confined in said first vessel and supported on said plate; said membrane being so distanced from an inner wall of said first vessel as to define an annular peripheral channel therebetween; said membrane having an axial passageway receiving permeate obtained as a result of concentration through said membrane; said axial passageway being blocked at said plate;
f) a submersed motor inside said second vessel;
g) a submersed pump inside said second vessel having one end connected to said motor for operation and an opposite end extending through said dividing wall and being in fluid communication with said membrane;
h) a pair of annular chambers in said second vessel; a first of said annular chambers being located adjacent said motor and being in fluid communication with said pump; a second of said annular chambers being located between said first chamber and an inner wall of said second vessel and being in fluid communication with said first annular chamber and with said annular channel of said first vessel through said passages in said dividing wall;
i) an inlet port to receive liquid to be separated; said inlet port being connected to said second annular chamber for mixture with concentrate received from said channel of said first vessel;
j) a first outlet port allowing concentrate to be collected outside said apparatus; and
k) a second outlet port in fluid communication with said axial passageway of said membrane allowing permeate to be collected outside said apparatus.

2. A liquid separation apparatus as defined in claim 1, wherein said first annular chamber of said second vessels consists of a tubular member surrounding said motor and said pump whereby concentrate passing through said chamber cools said motor.

3. A liquid separation apparatus as defined in claim 1 wherein said dividing wall consists of a plug interconnecting the contiguous ends of said vessels.

4. A liquid separation apparatus as defined in claim 1 wherein said pump is an axial pump.

5. A liquid separation apparatus as defined in claim 1 wherein said plate has a central opening receiving liquid from said pump for entrance at one end of said membrane.

6. A liquid separation apparatus as defined in claim 5 wherein said liquid travels longitudinally through said membrane to thereafter travel in said channel of said first vessel and through holes in said dividing wall into said second annular chamber of said second vessel.
